(19) United States
(12) Patent Application Publication
(10) Pub. No.: US 2025/0141242 A1
(43) Pub. Date: May 1, 2025

(54) CHARGING AND DISCHARGING DEVICE

(71) Applicant: SK On Co., Ltd., Seoul (KR)

(72) Inventors: Chang Mook HWANG, Daejeon (KR); Hyun Ji KIM, Daejeon (KR); Jae Woo PARK, Daejeon (KR); Ji Hyeon LEE, Daejeon (KR)

(21) Appl. No.: 18/923,679

(22) Filed: Oct. 23, 2024

(30) Foreign Application Priority Data
Oct. 25, 2023 (KR) 10-2023-0143785

(51) Int. Cl. H02J 7/00

(52) U.S. Cl. CPC H02J 7/0019; H02J 7/00716

(57) ABSTRACT

A charging and discharging device according to the present disclosure includes: a switching portion electrically connecting or blocking a first channel electrically connected to a first battery and a second channel electrically connected to a second battery; and a mainboard controlling a current supplied to the first channel according to a current value of a first charging and discharging recipe and controlling a current supplied to the second channel according to a current value of a second charging and discharging recipe, and when a current value of the first charging and discharging recipe exceeds a maximum value of a current supplied to the first channel, the mainboard controls the switching portion to electrically connect the first channel and the second channel to supply a current to the first battery through the first channel and the second channel.

### CROSS-REFERENCE TO RELATED PATENT APPLICATION

The present application claims priority under 35 U.S.C. § 119 (a) to Korean patent application number 10-2023-0143785 filed on Oct. 25, 2023, in the Korean Intellectual Property Office, the entire disclosure of which is incorporated by reference herein.

### BACKGROUND OF THE INVENTION

### 1. Field

The present disclosure relates to a battery cell, specifically, to a charging and discharging device.

### 2. Description of the Related Art

Batteries go through a formation process during the manufacturing process. The formation process is a process in which charging and discharging of batteries are repeated several times to impart electrical characteristics to the batteries. The formation process is carried out by a charging and discharging device.

A charging and discharging device includes a plurality of channels, and each channel is electrically connected to a battery. A charging and discharging device supplies a current to each channel to charge and discharge a battery, but since the amount of a current that can be supplied to the channel is limited, methods to increase the efficiency are required.

### SUMMARY OF THE INVENTION

The present disclosure aims to provide a charging and discharging device with improved current supply efficiency.

The present disclosure can be widely applied in the field of green technology, such as solar power generation and wind power generation. In addition, the present disclosure can be used in eco-friendly devices such as electric vehicles and hybrid vehicles to prevent climate change by suppressing air pollution and greenhouse gas emissions.

A charging and discharging device according to an embodiment includes: a switching portion electrically connecting or blocking a first channel electrically connected to a first battery and a second channel electrically connected to a second battery; and a mainboard controlling a current supplied to the first channel according to a current value of a first charging and discharging recipe and controlling a current supplied to the second channel according to a current value of a second charging and discharging recipe, and, when a current value of the first charging and discharging recipe exceeds a maximum value of a current supplied to the first channel, the mainboard controls the switching portion to electrically connect the first channel and the second channel to supply a current to the first battery through the first channel and the second channel.

In an embodiment, when a current value of the first charging and discharging recipe exceeds a maximum value of a current supplied to the first channel, the sum of the current supplied to the first channel and the current supplied to the second channel may be equal to the current value.

In an embodiment, when a current value of the first charging and discharging recipe exceeds a maximum value of a current supplied to the first channel, the first channel and the second channel may be electrically connected to each other.

In an embodiment, electrical connection of the second channel to the second battery may be blocked while the first channel and the second channel are electrically connected to each other.

In an embodiment, the second channel may supply a current to the first battery together with the first channel while the first channel and the second channel are electrically connected to each other.

In an embodiment, when a current value of the first charging and discharging recipe is less than or equal to a maximum value of the current supplied to the first channel and a current value of the second charging and discharging recipe is less than or equal to a maximum value of a current supplied to the second channel, the mainboard may control the switching portion to block electrical connection between the first channel and the second channel.

In an embodiment, the first channel may supply a current to the first battery while the electrical connection is blocked, and the second channel may supply a current to the second battery while the electrical connection is blocked.

In an embodiment, each of the first charging and discharging recipe and the second charging and discharging recipe may include: operation time of each of charging operation, standby operation, and charging operation; and a current value of a current supplied to a corresponding battery during the operation time.

In an embodiment, the current value of the charging operation may be less than or equal to a maximum value of a current supplied from the mainboard to a channel, and the current value of the discharging operation may exceed a maximum value of a current supplied from the mainboard to a channel.

In an embodiment, the current value of the standby operation may be 0 A.

In an embodiment, the operation time of the charging operation may be less than the operation time of the charging operation and of the standby operation.

In an embodiment, the discharging operation of the first charging and discharging recipe may be performed at a different time from the discharging operation of the second charging and discharging recipe.

In an embodiment, when the discharging operation of the first charging and discharging recipe and the discharging operation of the second charging and discharging recipe overlap, the mainboard may delay the discharging operation of the first charging and discharging recipe or the second charging and discharging recipe.

The present disclosure can provide a charging and discharging device with improved battery charging and discharging efficiency.

The present disclosure can provide a current exceeding a maximum supply current of one channel to a battery through multiple channels.

The present disclosure can efficiently perform charging and discharging of multiple batteries by utilizing a charging and discharging device with a low maximum supply current of one channel.

### BRIEF DESCRIPTION OF THE DRAWINGS

FIG. 1 shows a diagram for explaining a charging and discharging device according to an embodiment.

FIG. 2 shows a diagram for explaining a first mode of a charging and discharging device according to an embodiment.

FIG. 3 shows a diagram for explaining a second mode of a charging and discharging device according to an embodiment.

FIG. 4 shows a diagram for explaining a charging and discharging recipe according to an embodiment.

FIG. 5 shows a diagram for explaining charging and discharging operations of each battery according to an embodiment.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

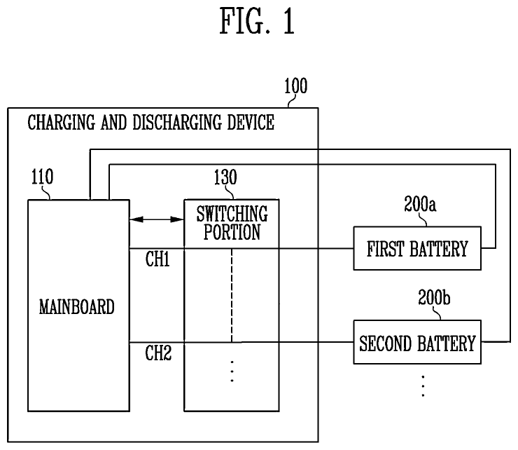

FIG. 1 shows a diagram for explaining a charging and discharging device according to an embodiment.

Referring to FIG. 1, a charging and discharging device 100 according to an embodiment may charge or discharge a plurality of batteries 200a and 200b. Each of the plurality of batteries 200a and 200b is a secondary battery that charges or discharges electric energy. Each of the plurality of batteries 200a and 200b may include a cathode, an anode, an electrolyte, and a case that accommodates these. For example, each of the plurality of batteries 200a and 200b may be one of the types classified into a lithium ion battery, a vanadium ion battery, a solid-state battery, a metal-air battery, a sodium ion battery, an aluminum ion battery, and the like depending on the material. As another example, each of the plurality of batteries 200a and 200b may be one of the types classified into a pouch type, a prismatic type, a cylindrical type, and the like depending on the shape of the case. The plurality of batteries 200a and 200b may include a first battery 200a and a second battery 200b.

A charging and discharging device 100 may include a mainboard 110 and a switching portion 130.

A mainboard 110 may control the overall components of a charging and discharging device 100. For example, a mainboard 110 may control a switching portion 130. In an embodiment, a mainboard 110 may include a processor that performs calculation or processing of data, and a current generation portion that generates a current or supplies a current to channels CH1 and CH2. In an embodiment, a charging and discharging device 100 may further include a chamber, an alternating current (AC)/direct current (DC) converter, a DC/DC converter, a DC/AC inverter, a power supply, and the like. A chamber may accommodate a battery 200a and 200b. For example, a chamber may include a jig from which a battery 200a and 200b is detachably attached. An AC/DC converter may convert AC power into DC power. A DC/DC converter may convert DC power into DC power of a set value. The DC/AC inverter may convert DC power that is output from a battery 200a and 200b into AC power when the battery 200a and 200b is discharged. The power supply may be an external power supply supplied to a charging and discharging device 100.

A mainboard 110 may charge and discharge a plurality of batteries 200a and 200b through a plurality of channels CH1 and CH2. For example, a plurality of channels CH1 and CH2 may include a first channel CH1 and a second channel CH2, and a plurality of batteries 200a and 200b may include a first battery 200a and a second battery 200b. Meanwhile, this is only an example, and the number of channels CH1 and CH2 and batteries 200a and 200b may be variously modified and implemented.

The mainboard 110 may provide a current to a battery 200a and 200b through a channel CH1 and CH2 for charging and discharging the battery 200a and 200b. For example, a mainboard 110 may individually supply a current to a plurality of channels CH1 and CH2. Each of a plurality of channels CH1 and CH2 may provide a current supplied from a mainboard 110 to a corresponding battery 200a and 200b. Here, the correspondence may mean an electrical connection.

A mainboard 110 may control a current supplied to a first channel CH1 according to a current value of a first charging and discharging recipe corresponding to a first battery 200a. A mainboard 110 may control a current supplied to a second channel CH2 according to a current value of a second charging and discharging recipe corresponding to a second battery 200b. In other words, a mainboard 110 may individually control (or adjust) a current to be supplied to a plurality of channels CH1 and CH2 according to a current value of a charging and discharging recipe. A charging and discharging recipe may include information about operation time of operations classified into charging operation, standby operation, discharging operation, and the like and a current value required to be provided to a battery 200a and 200b during the operation time of each operation.

A switching portion 130 may electrically connect at least two channels among a plurality of channels CH1 and CH2 to each other, or block electrical connection of at least two channels. For example, a switching portion 130 may be implemented in various forms such as a semiconductor element for a switch and a switch circuit.

In an embodiment, a switching portion 130 may electrically connect or block a first channel CH1 electrically connected to a first battery 200a and a second channel CH2 electrically connected to a second battery 200b.

A charging and discharging device 100 of the present disclosure may electrically connect a first channel CH1 and a second channel CH2 to each other through a switching portion 130. In this case, the first channel CH1 and the second channel CH2 may be electrically connected to a first battery 200a. In addition, the first channel CH1 and the second channel CH2 may provide the supplied current to the first battery 200a.

Meanwhile, depending on the performance of a charging and discharging device 100, a maximum value of a current supplied to each channel CH1 and CH2 may be limited. For example, when a current value of a charging operation of a charging and discharging recipe is 100 A and a current value of a discharging operation is 600 A, a maximum value of a current supplied to a channel CH1 and CH2 may be required to be designed to be 600 A or higher. At this time, in a general case, when the maximum value of the current supplied to the channel CH1 and CH2 is lower than 600 A (e.g., 300 A or the like), 600 A may not be provided to a corresponding battery 200a and 200b during the discharging operation. A charging and discharging device 100 of the present disclosure may provide a current having a current value of a charging and discharging recipe to a battery 200a and 200b through a switching portion 130, even when a maximum value of a current supplied to a channel CH1 and CH2 is lower than the current value of the charging and discharging recipe.

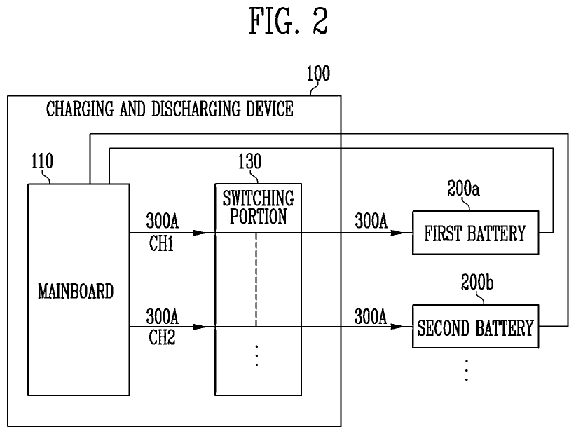

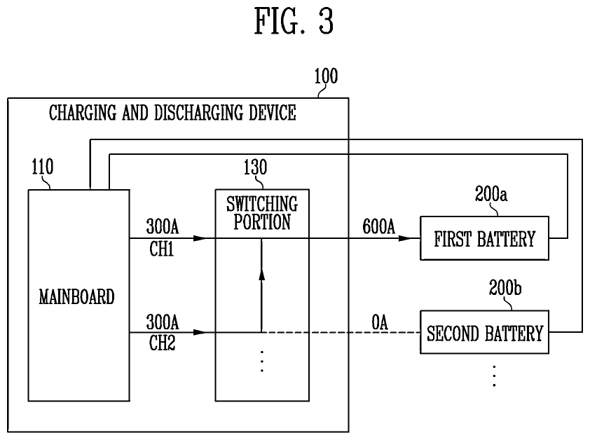

FIG. 2 shows a diagram for explaining a first mode of a charging and discharging device according to an embodiment. FIG. 3 shows a diagram for explaining a second mode of a charging and discharging device according to an embodiment.

Referring to FIGS. 2 and 3, a mainboard 110 may control a switching portion 130 according to the magnitude of a current value of a charging and discharging recipe. A switching portion 130 may be changed to one of a first mode and a second mode under the control of a mainboard 110. Here, the first mode may be a serial mode in which a current is provided from a channel connected to one battery in series, and the second mode may be a parallel mode in which a current is provided from a channel connected to one battery in parallel.

In an embodiment, referring to FIG. 2, when a current value of a first charging and discharging recipe is less than or equal to a maximum value of a current supplied to a first channel CH1 and a current value of a second charging and discharging recipe is less than or equal to a maximum value of a current supplied to a second channel CH2, a mainboard 110 may control a switching portion 130 to block electrical connection between the first channel CH1 and the second channel CH2. A switching portion 130 may block electrical connection between a first channel CH1 and a second channel CH2 according to a first mode. In this case, the first channel CH1 may be electrically connected to a first battery 200a, and the second channel CH2 may be electrically connected to a second battery 200b.

In an embodiment, a first channel CH1 may provide a current to a first battery 200a while electrical connection to a second channel CH2 is blocked. A second channel CH2 may provide a current to a second battery 200b while electrical connection to a first channel CH1 is blocked.

In an embodiment, a mainboard 110 may supply a current to a first channel CH1 according to a current value of a first charging and discharging recipe, and may supply a current to a second channel CH2 according to a value of a second charging and discharging recipe. For example, when current values of a first charging and discharging recipe and a second charging and discharging recipe are 300 A, a mainboard 110 may supply a current of 300 A to each of a first channel CH1 and a second channel CH2. In addition, the first channel CH1 may provide the supplied current to a first battery 200a, and the second channel CH2 may provide the supplied current to a second battery 200b. In other words, a current of 300 A may be provided to each of the first battery 200a and the second battery 200b.

In an embodiment, referring to FIG. 3, when a current value of a first charging and discharging recipe exceeds a maximum value of a current supplied to a first channel CH1, a mainboard 110 may control a switching portion 130 to electrically connect a first channel CH1 and a second channel CH2 to supply a current to a first battery 200a through the first channel CH1 and the second channel CH2. In this case, the switching portion 130 may electrically connect the first channel CH1 and the second channel CH2 to each other according to a second mode. In this case, the first channel CH1 and the second channel CH2 may be electrically connected to the first battery 200a. In an embodiment, electrical connection of a second channel CH2 to a second battery 200b may be blocked by a switching portion 130.

In an embodiment, when a current value of a charging and discharging recipe exceeds a maximum value of a current supplied to a first channel CH1, the sum of a current supplied to a first channel CH1 and a current supplied to a second channel CH2 may be equal to a current value of the first charging and discharging recipe.

In an embodiment, a second channel CH2 may provide a current to a first battery 200a together with a first channel CH1 while the first channel CH1 and the second channel CH2 are electrically connected to each other.

In an embodiment, a second channel CH2 may not provide a current to a second battery 200b while providing a current to a first battery 200a together with a first channel CH1.

For example, when a current value of a first charging and discharging recipe is 600 A and a maximum value of a current supplied to a first channel is 300 A, this may correspond to a case where a current value of a first charging and discharging recipe exceeds a maximum value of a current supplied to a first channel CH1. In this case, a mainboard 110 may control a switching portion 130 to become a second mode. A mainboard 110 may control a current supplied to a first channel CH1 and a current supplied to a second channel CH2 so that the sum of a value of the current supplied to the first channel CH1 (e.g., 300 A) and a value of the current supplied to the second channel CH2 (e.g., 300 A) becomes a current value of a first charging and discharging recipe (e.g., 600 A). A mainboard 110 may supply a current of 300 A to each of a first channel CH1 and a second channel CH2. In addition, the first channel CH1 may provide the supplied current to a first battery 200a, and the second channel CH2 may provide the supplied current to the first battery 200a. In other words, a current of 600 A may be provided to a first battery 200a, and a current of 0 A may be provided to a second battery 200b.

Meanwhile, a charging and discharging device 100 may include three or more channels. In an embodiment, when the sum of a current supplied to a first channel CH1 and a current supplied to a second channel CH2 is less than a current value of a first charging and discharging recipe, a mainboard 110 may provide a current to a first battery 200a through three or more channel. For example, when a current value of a first charging and discharging recipe is 900 A and a maximum value of a current supplied to each of first to third channels is 300 A, a mainboard 110 may control a switching portion 130 so that the first to third channels are electrically connected to each other. The mainboard 110 may supply a current of 300 A to each of the first to third channels, and each of the first to third channels may provide the supplied current to a first battery 200a. In other words, the first battery 200a may receive a current of 300 A from each of the first to third channels, thus receiving a total current of 900 A.

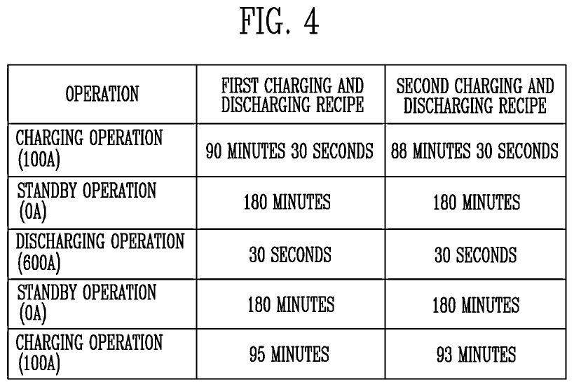

FIG. 4 shows a diagram for explaining a charging and discharging recipe according to an embodiment.

Referring to FIG. 4, each of a first charging and discharging recipe and a second charging and discharging recipe according to an embodiment may include a plurality of operations for charging and discharging a corresponding battery. For example, each of a plurality of operations may be one of charging operation, standby operation, and discharging operation. A first charging and discharging recipe may correspond to a first battery 200a, and a second charging and discharging recipe may correspond to a second battery 200b.

In an embodiment, a charging and discharging recipe may include operation time and current value of each of charging operation, standby operation, and discharging operation. A current value may be a value of a current provided to a corresponding battery during operation time of each of charging operation, standby operation, and discharging operation. In other words, a current value of a charging operation may be a value of a current provided to a corresponding battery during the charging operation. A current value of a discharging operation may be a value of a current provided to a corresponding battery during the discharging operation. A current value of a standby operation may be a value of a current provided to a corresponding battery during the standby operation.

In an embodiment, a current value of a charging operation included in a charging and discharging recipe may be less than or equal to a maximum value of a current supplied from a mainboard 110 to a channel. For example, a maximum value of a current supplied from a mainboard 110 to a channel may be 300 A, and a current value of a charging operation may be 100 A.

In an embodiment, a current value of a discharging operation included in a charging and discharging recipe may exceed a maximum value of a current supplied from a mainboard 110 to a channel. For example, a maximum value of a current supplied from a mainboard 110 to a channel may be 300 A, and a current value of a discharging operation may be 600 A.

In an embodiment, a current value of discharging operation included in a charging and discharging recipe may be 0 A.

In an embodiment, operation time of a discharging operation included in a charging and discharging recipe may be shorter than operation time of a charging operation and operation time of a standby operation. For example, operation time of a discharging operation may be 30 seconds, operation time of a standby operation may be 180 minutes, and operation time of a charging operation may be set to 90 minutes 30 seconds, 88 minutes 30 seconds, 95 minutes, 93 minutes, or the like.

In an embodiment, operations included in each of a first charging and discharging recipe and a second charging and discharging recipe may be sequentially performed by a mainboard 110 according to operation time. For example, according to a first charging and discharging recipe, a charging operation may be performed for 90 minutes and 30 seconds, then a standby operation may be performed for 180 minutes, then a discharging operation may be performed for 30 seconds, then a standby operation may be performed for 180 minutes, and then a charging operation may be performed for 95 minutes.

In an embodiment, a discharging operation of a first charging and discharging recipe and a discharging operation of a second charging and discharging recipe may be performed at different times. For example, operation time of a first charging and discharging recipe and a second charging and discharging recipe may be set so that a discharging operation of each of the first charging and a discharging recipe and the second charging and discharging recipe are performed at different times.

Meanwhile, at least one of the sequence of operations, operation time, and current in a charging and discharging recipe may vary depending on the type and capacity of a battery.

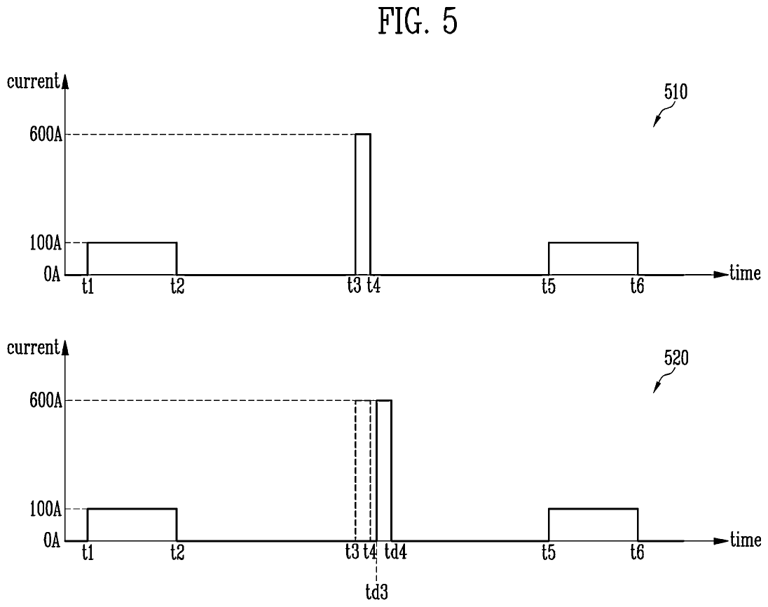

FIG. 5 shows a diagram for explaining charging and discharging operations of each battery according to an embodiment.

Referring to FIG. 5, a first graph 510 and a second graph 520 show the amount of current provided to each battery through each channel during each operating time according to a charging and discharging recipe. A first graph 510 shows a current provided to a first battery (200a), and a second graph 520 shows a current provided to a second battery 200b.

In an embodiment, each of a first charging and discharging recipe and a second charging and discharging recipe may include a first charging operation, a first standby operation, a discharging operation, a second standby operation, and a second charging operation.

For example, current values of a first charging operation and a second charging operation may be 100 A, current values of a first standby operation and a second standby operation may be 0 A, a current value of a discharging operation may be 600 A, and a maximum value of a current supplied to each channel may be 300 A.

In this case, a mainboard 110 may determine that the current values of the discharging operations included in the first and second charging and discharging recipes exceed the maximum value of the current supplied to each channel CH1 and CH2. Then, the mainboard 110 may control the switching portion 130 so that the first channel CH1 and the second channel CH2 are electrically connected to each other while the discharging operations included in the first and second charging and discharging recipes are performed. For example, as shown in the first graph 510, the mainboard 110 may control the switching portion 130 so that the first channel CH1 and the second channel CH2 are electrically connected to each other during the time from t3 to t4. In this case, the mainboard 110 may supply a current of 300 A to each of the first channel CH1 and the second channel CH2. The first battery 200a may receive a current from each of the first channel CH1 and the second channel CH2, thus receiving a total current of 600 A. Meanwhile, a mainboard 110 may determine that current values of each of a first charging operation, a first standby operation, a second standby operation, and a second charging operation included in first and second charging and discharging recipes are smaller than a maximum value of a current supplied to each channel CH1 and CH2.

In an embodiment, when the times of a discharging operation of a first charging and discharging recipe and a discharging operation of a second charging and discharging recipe overlap, a mainboard 110 may delay the discharging operation of the first charging and discharging recipe or the second charging and discharging recipe. Here, the current value of the discharging operation may exceed a maximum value of a current supplied to a channel CH1 and CH2.

For a specific example, as shown in FIG. 5, a first charging and discharging recipe and a second charging and discharging recipe may be set so that discharging operations for a first battery 200a and a second battery 200b are performed during overlapping time from t3 to t4. In this case, a mainboard 110 may delay the discharging operation of the second charging and discharging recipe so that the discharging operation for the first battery 200a and the discharging operation for the second battery 200b do not overlap with each other even partially.

In an embodiment, a mainboard 110 may perform a discharging operation for a first battery 200a during the time from t3 to t4 and delay a discharging operation for a second battery 200b, performing it during the time from td3 to td4.

For a specific example, a mainboard 110 may control a switching portion 130 so that a first channel CH1 and a second channel CH2 are electrically connected to each other during the time from t3 to t4. At this time, the first channel CH1 and the second channel CH2 are electrically connected to a first battery 200a by the switching portion 130, and electrical connection between the second channel CH2 and a second battery 200b may be blocked. The mainboard 110 may supply a current of 300 A to each of the first channel CH1 and the second channel CH2. The first battery 200a may receive a current from each of the first channel CH1 and the second channel CH2, thus receiving a total current of 600 A.

Thereafter, the mainboard 110 may control the switching portion 130 so that the first channel CH1 and the second channel CH2 are electrically connected to each other during the time from td3 to td4. At this time, the first channel CH1 and the second channel CH2 are electrically connected to the second battery 200b by the switching portion 130, and electrical connection between the first channel CH1 and the first battery 200a may be blocked. The mainboard 110 may supply a current of 300 to each of the first channel CH1 and the second channel CH2. The second battery 200b may receive a current from each of the first channel CH1 and the second channel CH2, thus receiving a total current of 600 A.

According to the above-described embodiments of the present disclosure, a charging and discharging device 100 with improved battery charging and discharging efficiency can be provided. In addition, a current exceeding a maximum supply current of one channel can be provided to a battery through multiple channels. A charging discharging device 100 with a low maximum supply current of one channel can be used to efficiently perform charging and discharging of a plurality of batteries. According to the present disclosure, operations requiring a high current can be performed without overlapping each other, thereby increasing the operating efficiency of channels.

What is claimed is:

1. A charging and discharging device comprising:
a switching portion electrically connecting or blocking a first channel electrically connected to a first battery and a second channel electrically connected to a second battery; and
a mainboard controlling a current supplied to the first channel according to a current value of a first charging and discharging recipe and controlling a current supplied to the second channel according to a current value of a second charging and discharging recipe,
wherein, when a current value of the first charging and discharging recipe exceeds a maximum value of a current supplied to the first channel, the mainboard controls the switching portion to electrically connect the first channel and the second channel to supply a current to the first battery through the first channel and the second channel.

2. The charging and discharging device of claim 1, wherein, when a current value of the first charging and discharging recipe exceeds a maximum value of a current supplied to the first channel, the sum of the current supplied to the first channel and the current supplied to the second channel is equal to the current value.

3. The charging and discharging device of claim 1, wherein, when a current value of the first charging and discharging recipe exceeds a maximum value of a current supplied to the first channel, the first channel and the second channel are electrically connected to each other.

4. The charging and discharging device of claim 3, wherein electrical connection of the second channel to the second battery is blocked while the first channel and the second channel are electrically connected to each other.

5. The charging and discharging device of claim 4, wherein the second channel supplies a current to the first battery together with the first channel while the first channel and the second channel are electrically connected to each other.

6. The charging and discharging device of claim 1, wherein, when a current value of the first charging and discharging recipe is less than or equal to a maximum value of the current supplied to the first channel and a current value of the second charging and discharging recipe is less than or equal to a maximum value of a current supplied to the second channel, the mainboard controls the switching portion to block electrical connection between the first channel and the second channel.

7. The charging and discharging device of claim 6, wherein the first channel supplies a current to the first battery while the electrical connection is blocked, and the second channel supplies a current to the second battery while the electrical connection is blocked.

8. The charging and discharging device of claim 1, wherein each of the first charging and discharging recipe and the second charging and discharging recipe includes:
operation time of each of charging operation, standby operation, and charging operation; and
a current value of a current supplied to a corresponding battery during the operation time.

9. The charging and discharging device of claim 8, wherein the current value of the charging operation is less than or equal to a maximum value of a current supplied from the mainboard to a channel, and the current value of the discharging operation exceeds a maximum value of a current supplied from the mainboard to a channel.

10. The charging and discharging device of claim 8, wherein the current value of the standby operation is 0 A.

11. The charging and discharging device of claim 8, wherein the operation time of the discharging operation is less than the operation time of the charging operation and of the standby operation.

12. The charging and discharging device of claim 8, wherein the discharging operation of the first charging and discharging recipe is performed at a different time from the discharging operation of the second charging and discharging recipe.

13. The charging and discharging device of claim 8, wherein, when the discharging operation of the first charging and discharging recipe and the discharging operation of the second charging and discharging recipe overlap, the mainboard delays the discharging operation of the first charging and discharging recipe or the second charging and discharging recipe.
